(19) United States
(12) Patent Application Publication
(10) Pub. No.: US 2007/0025587 A1
(43) Pub. Date: Feb. 1, 2007

(54) Subwoofer design and isolator therefor

(75) Inventor: Stefan R. Hlibowicki, Toronto (CA)

Correspondence Address: BERESKIN AND PARR, 40 KING STREET WEST, BOX 401, TORONTO, ON, M5H 3Y2, CA

(73) Assignee: Audio Products International Corp., Scarborough (CA)

(21) Appl. No.: 11/175,261

(22) Filed: Jul. 7, 2005

(51) Int. Cl. H04R 9/06; H04R 11/02

(52) U.S. Cl. 381/412

(57) ABSTRACT

A speaker has a magnet assembly, a basket and a voice coil mounted in the flux gap of the magnet assembly. A spider mounts the voice coil to align it. A sound radiator, for producing sound, is connected by a connector to the voice coil. An isolator extends across the basket, between the sound radiator and the voice coil, to isolate the voice coil mechanically from the exterior, while permitting free movement of the connector. This then enables the voice coil to be connected to and driven by an amplifier connected to a relatively high voltage electrical supply.

### FIELD OF THE INVENTION

This invention relates to loud speakers, and more particularly is concerned with loudspeakers commonly classified as subwoofers and intended to reproduce sound in just a low frequency range. Subwoofers are usually used as part of a speaker system including other speakers intended to produce other audio frequencies, so as to provide a complete range of frequencies covering the entire range of frequencies audible to the human ear.

### BACKGROUND OF THE INVENTION

Presently, many consumers and purchasers of audio systems expect such systems both to adequately reproduce frequencies down to quite low frequencies and to reproduce such low frequencies at relatively high power levels. In other words, consumers enjoy and appreciate bass or low frequency sounds. To meet this demand, current sound systems typically provide a separate, stand-alone subwoofer. Unlike higher frequencies, it is not critical to provide any dimensional or stereo aspect to low frequency sound, and it is acceptable to provide a single subwoofer; in contrast, speakers for other frequencies are usually provided either in pairs, for a stereo sound system or in a larger number to provide a surround sound effect.

A further common requirement in the market place is that such subwoofers should be relatively small and compact. A requirement for compact subwoofers and high sound output require the subwoofer to have a relatively large power.

A further complication is that design codes in major industrial countries, including United States and Canada, usually require that any live components not be readily accessible by the user. These codes typically include tests to determine if an enclosure can be penetrated by a user, e.g. by dropping weights of a specified size and shape on the speaker cones, probing speaker enclosures with a simulated finger. It is also common to include a minimum “creepage” discharge distance or length. This requires that there be a minimum distance between any live components and the exterior of a speaker enclosure or parts that provide an electrical connection to the exterior, including any paths between surfaces of fitted components and the like.

For simple, low power applications, passive subwoofers can be provided, which do not incorporate any separate amplifier. Where any significant power level is required, it is not practical to supply this power as an audio signal from a separate amplifier. Rather, the only practical approach is to supply the audio signal at a low power level to the subwoofer, and then to amplify this signal within the subwoofer to generate necessary power level. However, this then introduces the requirement to supply electrical power to the subwoofer and, consequently, the subwoofer itself may not meet the requirements for electrical isolation of any live components if this issue is not properly addressed.

This places severe design constraints on manufacturers of such subwoofers. One typical approach would be to provide an isolation transformer between the power line and the amplifier within the subwoofer. This would then enable the live components to be isolated from the accessible parts of the subwoofer, thereby simplifying the overall design in compliance with design codes. However, for a subwoofer of any reasonable power, for example of the order of a few hundred watts or higher, it can quickly be determined that the size of the necessary transformer would be quite large and expensive. This then takes up some considerable space within the subwoofer enclosure also.

A power transformer can be eliminated if other means of isolation are provided. One solution to this problem is to provide a grille or mesh, formed from metal or other durable material, covering the exterior of a speaker. For various reasons, this is not preferred. It adds to the bulk and external dimensions of the speakers, which can in turn limit the internal volume. Any such metal grille is usually considered unsightly and unattractive, and hence rejected for marketing reasons.

### SUMMARY OF THE INVENTION

The present invention is based on the realization that, particularly, but not exclusively, for subwoofers of significant power levels, it is desirable to eliminate the need for any power transformer, and further that it is possible to do this while complying with codes governing isolation of electrically live components.

In accordance with a first aspect of the present invention, there is provided a speaker comprising:
a magnet assembly defining a magnetic flux gap;
a voice coil mounted in the flux gap extending parallel to an axis of the speaker;
a sound radiator;
a connector, connecting the voice coil to the sound radiator, to drive the sound radiator; and
an isolator mounted between the sound radiator and the magnet assembly, to at least restrict access to electrically conductive parts the speaker that might become live while not restricting movement of the voice coil and the sound radiator.

Preferably, the speaker includes a basket, with the magnet assembly and the isolator mounted to the basket, and with a spider provided between the basket and voice coil to align the voice coil.

The isolator can include a central portion including a plurality of openings permitting free movement of air through the isolator.

The connector can comprises a voice coil extender including a generally circular base portion and the plurality of leg portions extending from the base portion, or the connector can comprise an extension of a bobbin of the voice coil.

The sound radiator advantageously has a generally planar exterior surface for generating sound, and can include a plurality of ribs on a rear face thereof, to reinforce the planar exterior surface.

The present invention also provides an isolator for use in a speaker, the isolator comprising:
a central portion including a plurality of openings permitting free passage of air therethrough and a plurality of apertures for leg portions of a connector connecting, in use, a voice coil and a sound radiator, and permitting free movement of the leg portions therethrough; and
a peripheral portion including a mounting flange.

For some applications it may be possible to have a single leg portion and just one aperture in the isolator. Also, for use with passive drivers, there is not need to provide any apertures as there is no connection to any leg portions required.

It is also possible for some applications that the active driver could be provided with a different structure, and that the isolator would only be needed for the passive drivers. In such a case, the isolator would not need any apertures for leg portions or the like, but instead would simply need openings to permit free movement of air.

A further aspect of the present invention provides a voice coil extender comprising a base portion for connection to a voice coil and a plurality of legs extending generally parallel to one another away from the base portion.

### BRIEF DESCRIPTION OF THE DRAWINGS

For a better understanding of the present invention and to show more clearly how it may be carried into effect, reference will now be made, by way of example, to the accompanying drawings in which:

FIG. 1a is a view of a horizontal cross-section through a subwoofer in accordance with the present invention;

FIG. 1b is a view of a horizontal cross-section similar to FIG. 1b, and showing an alignment tool;

FIG. 2 is a perspective view of elements of the subwoofer of the present invention, showing the main elements of the active driver, except for a flat sound radiator;

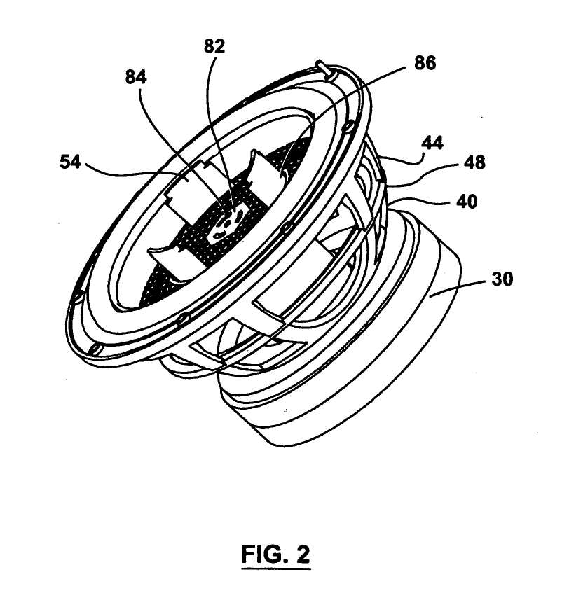

FIG. 3 is a perspective view showing the active driver and the amplifier;

FIG. 4 is a perspective view showing the arrangement of the active and passive sound radiators in the enclosure;

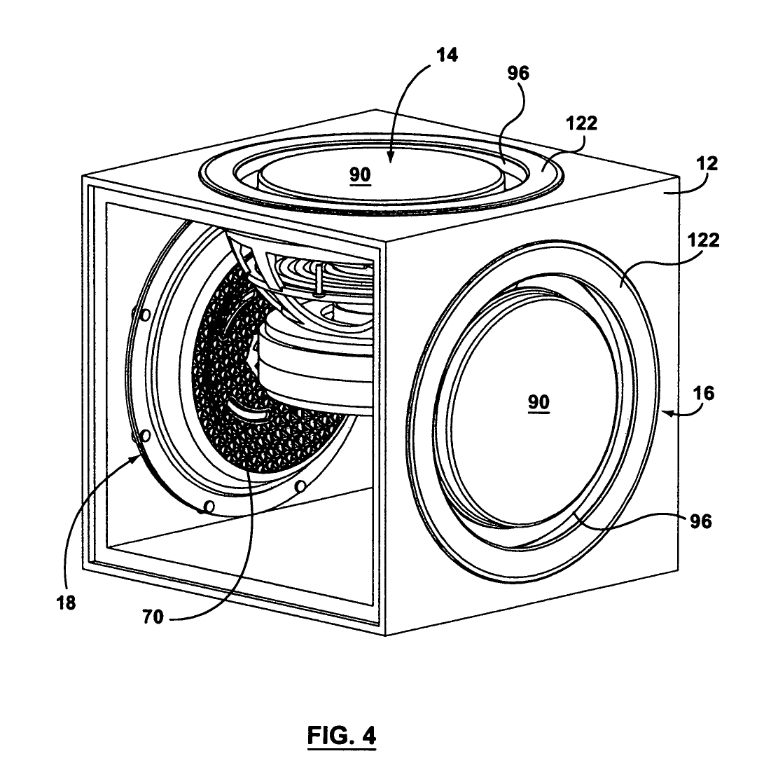

FIG. 5 is a further perspective view showing details of a trim piece;

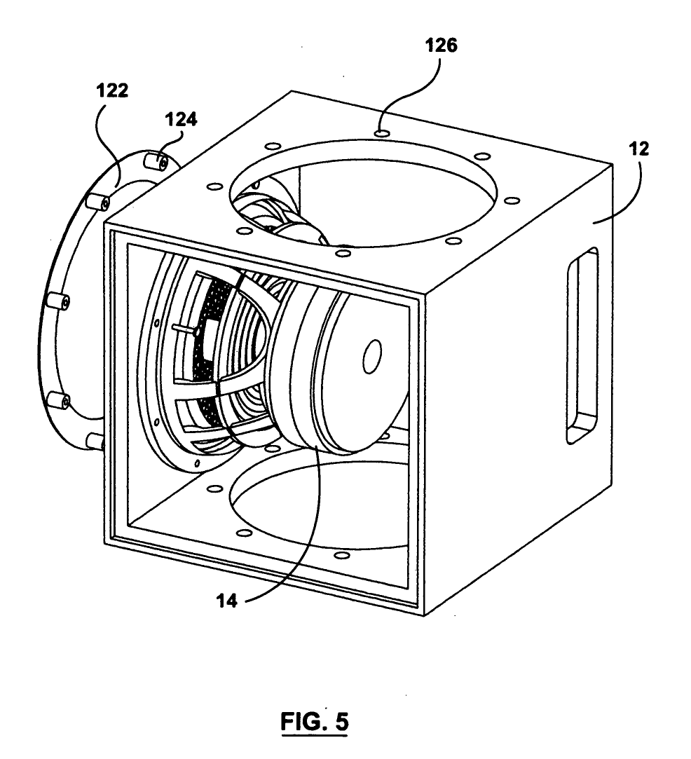

FIG. 6 is a perspective view showing a voice coil extender in accordance with the present invention;

FIG. 7 is a perspective view showing a voice coil extender, a voice coil and a spider in combination;

FIG. 8 is a perspective view showing the combination of elements of FIG. 7 and including a mounting and alignment tool;

FIG. 9 is a perspective view showing the combination of the voice coil extender and the voice coil, mounted to a sound radiator and its surround;

FIG. 10 is a perspective view showing the complete woofer, including the mounting and alignment tool and with the sound radiator removed;

FIG. 11 is a perspective view showing the complete woofer;

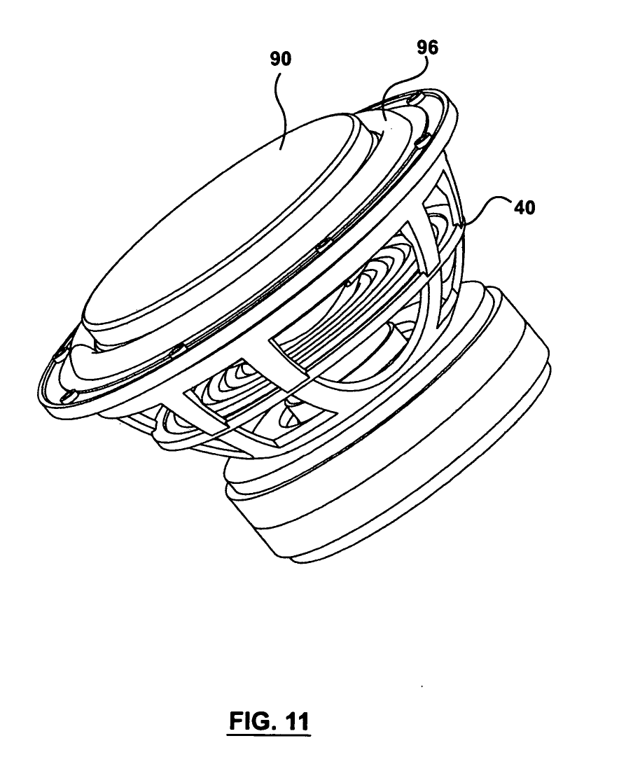

FIG. 12 is a perspective view of the isolator from the front;

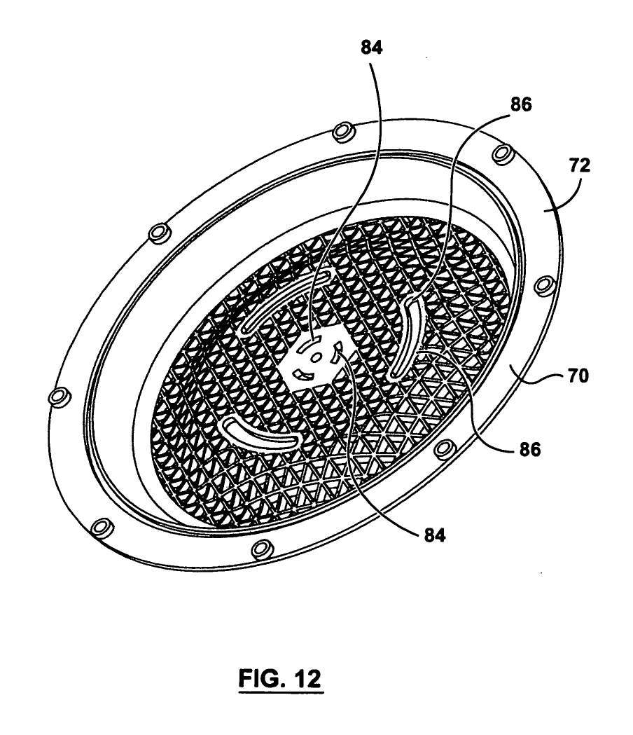

FIG. 13 is a perspective view of the isolator from the rear;

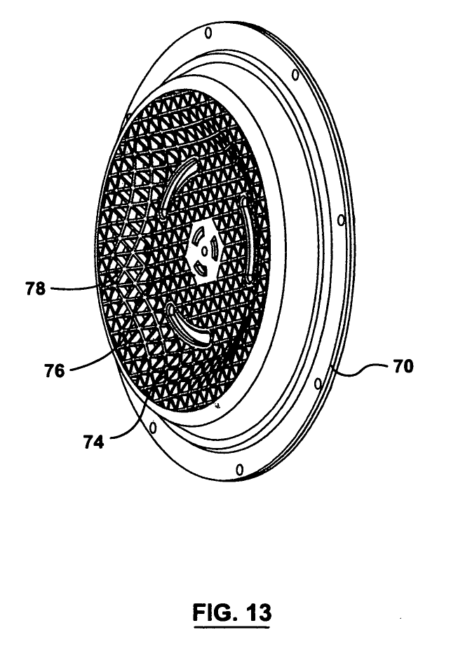

FIG. 14 is a perspective view showing the mounting and alignment tool; and

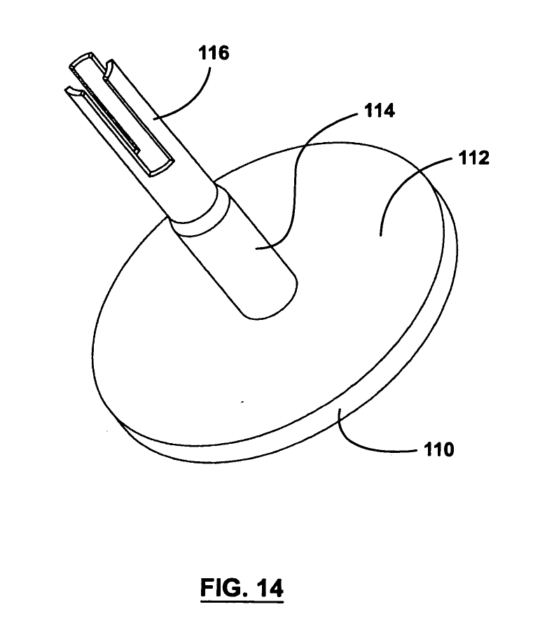

FIG. 15 is a perspective view of the rear of the sound radiator of a passive radiator.

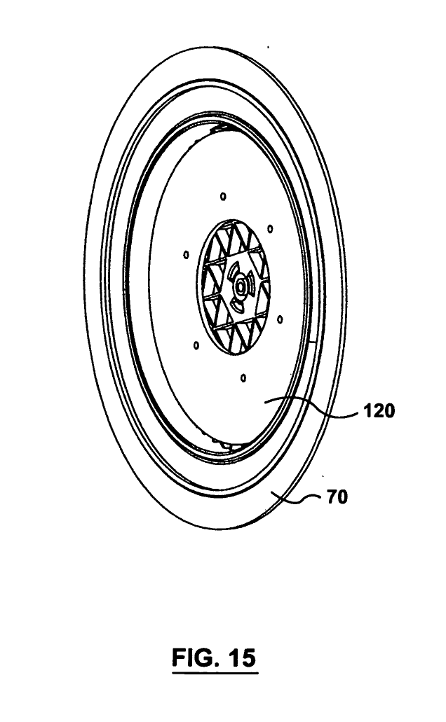

### DETAILED DESCRIPTION OF THE INVENTION

In the figures, a subwoofer in accordance with the present invention is indicated generally by the reference 10. The subwoofer 10 has an enclosure 12, and in the disclosed embodiment, the enclosure 12 is of a generally cubic shape. However, it will be understood that any suitable shape of enclosure can be used; the enclosure need not necessarily comprise purely flat surfaces, and any flat surfaces are not restricted to always being perpendicular to one other.

The subwoofer 10 has an active driver or radiator 14, otherwise known as a woofer, and two passive radiators 16 and 18. Again, the combination of active and passive radiators is not critical to the present invention, and it is possible that just one or more active drivers or radiators could be provided with no passive radiators, and also that conventional vents could be provided. Further, where passive radiators are provided, the number of passive radiators 16, 18 can be varied, as required.

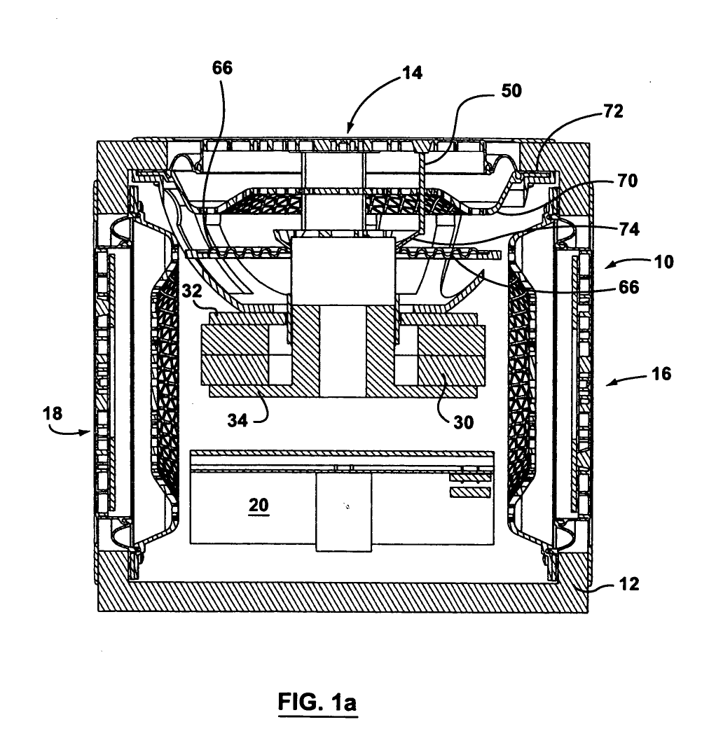

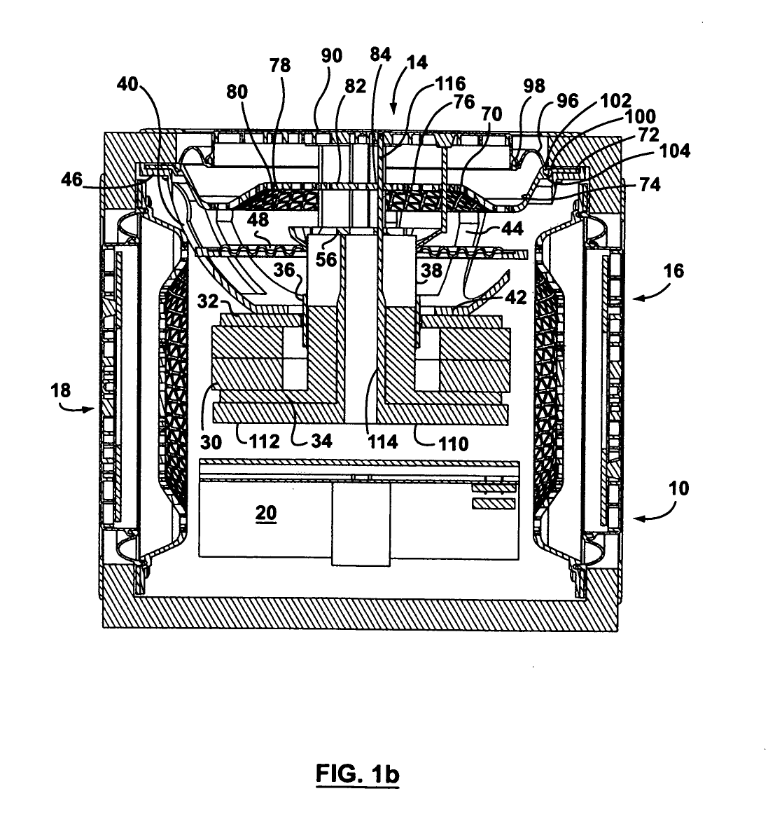

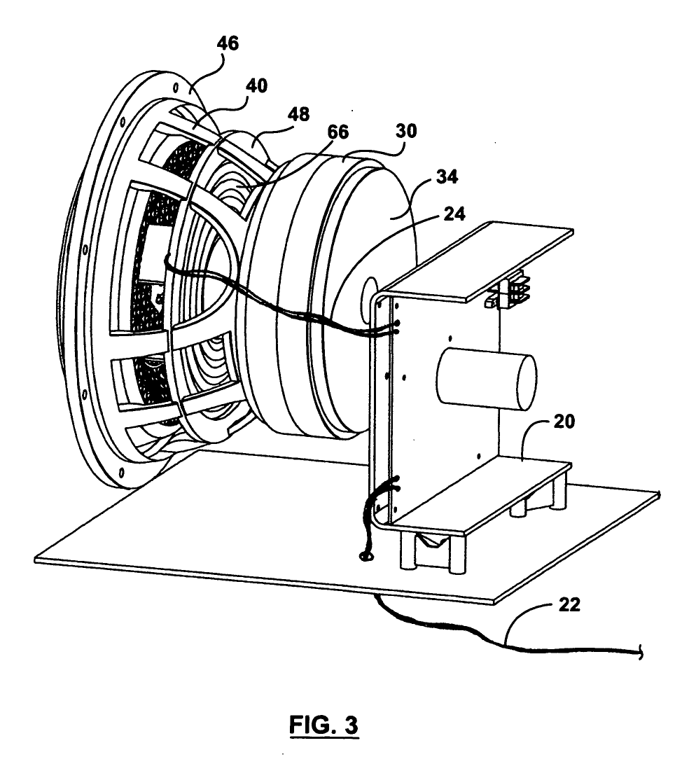

FIG. 1 also shows an amplifier 20, shown schematically, since the details of the amplifier form no part of the present invention. The amplifier 20 is provided with a power supply connection 22 (FIG. 3). The amplifier 20 is thus connected directly to an electrical power supply, which, commonly, is at a voltage of either 120 volts (in North America) or 240 volts (applicable in many other countries) AC. As detailed below, the amplifier 20 has connections 24 to the motor elements of the active driver 14, so that both the amplifier 20, and possibly also the active driver 14, are subject to the voltages of the power supply.

Turning to details of the active driver 14, many components can be, to at least some extent, conventional. Thus, the driver 14 includes a magnet 30, provided with a top plate 32 and a yoke 34. The top plate 32 and yoke 34 together define an annular gap in which is mounted a voice coil 36. In known manner, the voice coil 36 is connected to the amplifier 20, so that the signal from the amplifier 20 drives the voice coil. The magnet 30, top plate 32 and the yoke 34 form a magnet assembly.

A basket 40, usually formed from cast iron, aluminum or an aluminum alloy, has a planar bottom plate 42, connected to a plurality of spokes 44. The spokes 44 in turn are connected at their upper ends to an annular mounting flange 46. Additionally, an intermediate or mounting ring 48 extends between the spokes 44, to provide further strength to the basket 40, and is used to mount a spider 66.

The voice coil 36 is formed on a cylindrical former or bobbin 38, that extends up above the actual voice coil 36 itself (It is here noted that references to orientation, such as “top”, “above”, etc. are with reference to the active driver 14 as shown in FIG. 1 and following common convention. It will be understood that the active driver 14 can, in use, be placed in any orientation). In conventional subwoofers, the upper end of the former 38 is connected to a frusto-conical cone and the former is usually closed off by a dust cap, so as to form the actual sound-producing element or radiator.

While the strength of the cone in particular, and also possibly the dust cap, are usually very dependent upon the size and power of the speaker and may be quite substantial for large, high powered subwoofers. They are nonetheless almost always not very strong elements. Since the cone necessarily must move to generate the sound, it is highly desirable to maintain the mass of the cone as low as possible. Additionally, the various components are glued together and the glue used is not reliable. For this reason, it is believed that the cone itself and its surround would generally never meet standards for an enclosure, to prevent access to electrically live components. As detailed above, one option is to consider substantial metal grilles or the like on the outside of the speaker. However, for aesthetic and other reasons, these are undesirable.

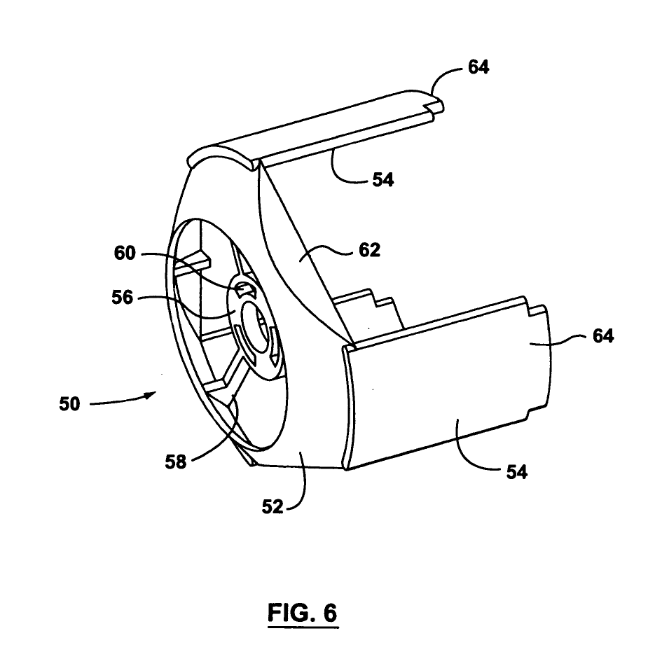

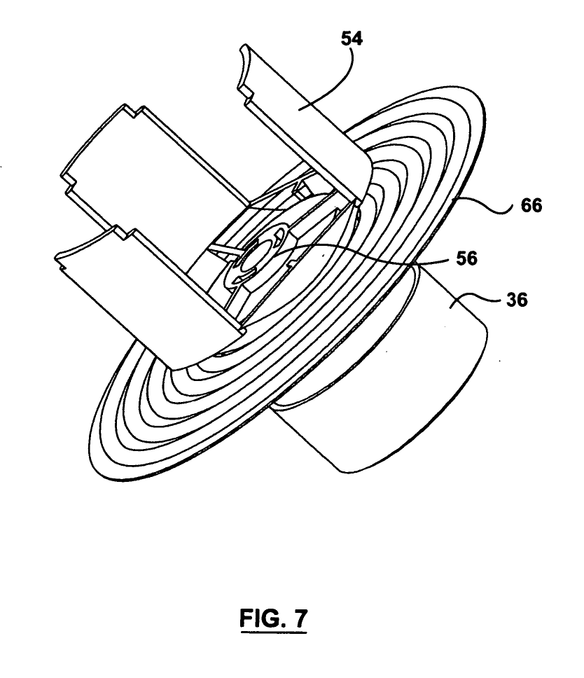

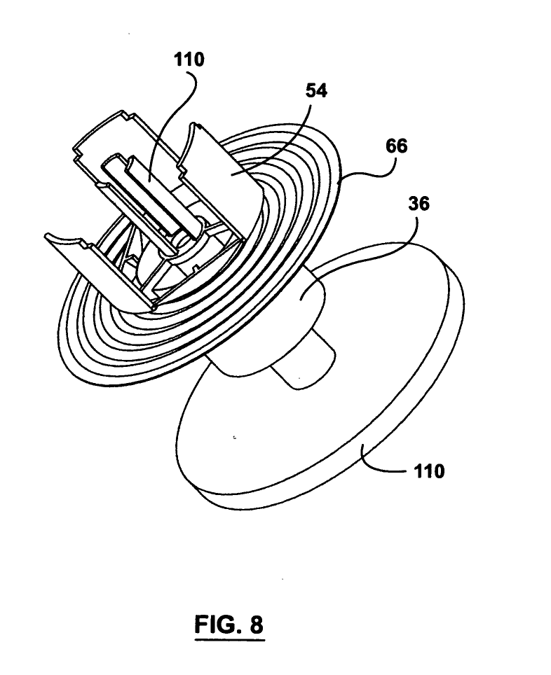

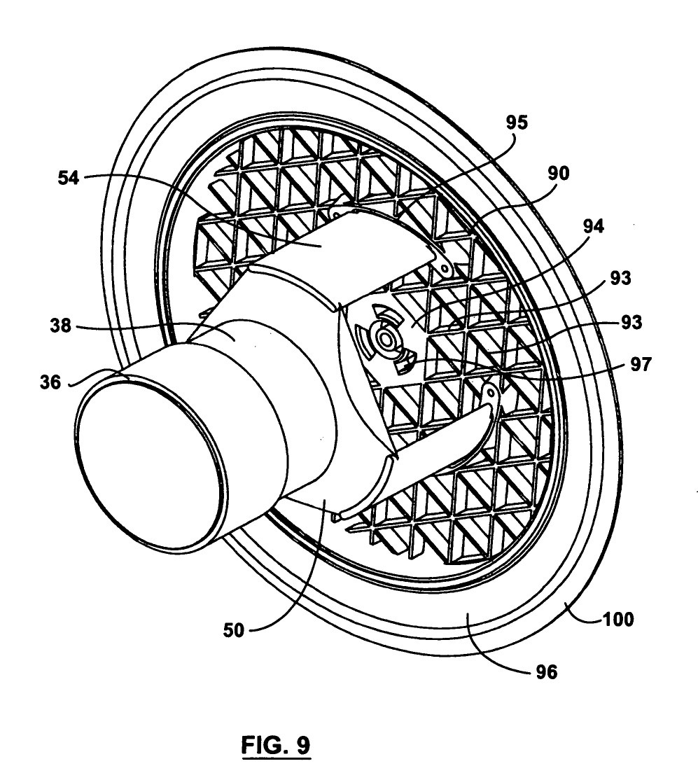

In accordance with the present invention, a voice coil extender 50 is connected to the voice coil former 38, as best shown in FIGS. 6 to 9. The voice coil extender 50 comprises a base portion 52, having essentially an annular shallow conical shape. Elongate arcuate leg portions 54 extend outwardly from the base portion 52 and parallel to an axis of the driver 14 and voice coil extender 50. For some applications, the voice coil extender could comprise an extension of the former or bobbin 38.

A central alignment collar 56 is connected by ribs 58 to the base portion 52 and includes arcuate apertures 60 for aligning the various components of the driver 14, as detailed below.

Flat surface portions 62 extend between the elongate arcuate portions 54. The ends of the elongate arcuate portions 54 are cut back to provide connecting end portions 64.

In known manner the spider 66 is connected between the voice coil former or bobbin 38 and the mounting ring 48 of the basket 40. This spider 66 can be of largely conventional construction.

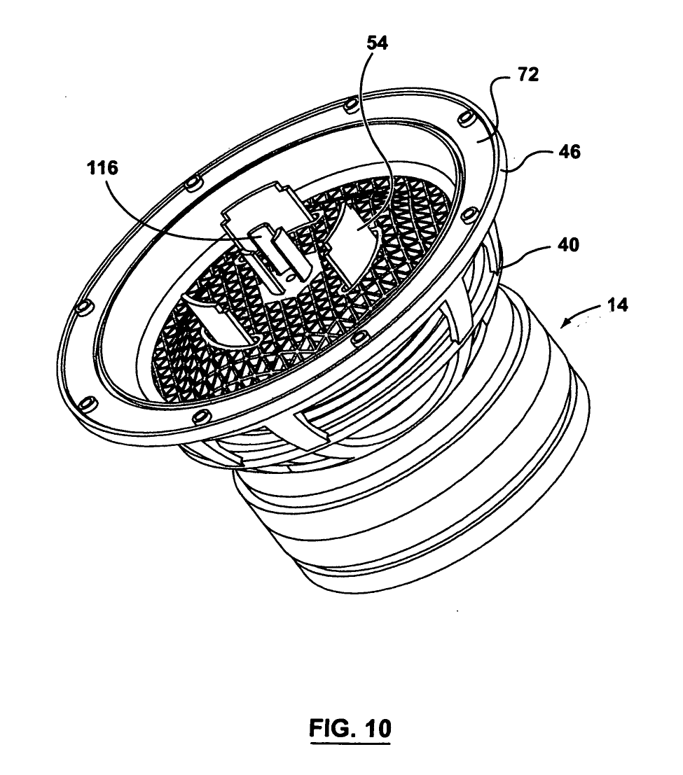

Further in accordance with the present invention, there is provided an isolator indicated at 70. The isolator 70 is largely disc-shaped, and includes an annular mounting flange 72, that can include raised cylindrical projections (FIG. 10) for engaging openings in a flange of a surround, or for location around that flange. Radially inwardly from the flange 72, there is a frusto-conical portion 74, that serves to space a central portion of the isolator 70 inwardly from the enclosure 12.

A central portion 76 of the isolator 70 is in the form of a mesh. The mesh or central portion 76 is formed from three sets of parallel ribs 78, that extend and intersect to form a plurality of triangular openings 80. Here, triangular openings are each in the form of an equilateral triangle.

The triangular openings 80 are dimensioned to meet the requirements for a finger-probing test. A common test uses a simulated or artificial finger of specified dimensions, so that the openings 80 are dimensioned to be small enough to prevent penetration of this artificial finger. Triangular openings 80 have been found to be the best shape to give the maximum opening size while meeting this finger test.

Nonetheless, it will be understood that openings of any shape and size could be used, provided they meet the required regulations or specifications. Thus, the openings need not all be of the same size and shape, and could, for example, be circular, square, etc.

A central part 82 of the isolator 70 does not have the openings 80, but instead has arcuate slots 84 for an alignment tool. Additionally, spaced further out radially, arcuate slots 86 are provided for the leg portions 54 of the voice coil extender, these being of sufficiently large dimensions to provide for unrestricted movement of the voice coil extender 50, and to allow for some lateral movement of the leg portions 54 in the arcuate slots 84.

The actual sound-producing element or radiator is indicated at 90. Unlike conventional subwoofers or speakers which utilize a cone construction, the sound-producing radiator 90 has a planar exterior surface 92 and is generally circular. On the rear of the surface 92, there is a pattern of ribs 93 serving to reinforce the surface 92, and dimensioned to ensure that any natural frequency of vibration of the radiator 90 is higher than the frequencies delivered by the subwoofer 10, so that it will not interfere with the performance of the subwoofer 10.

A flexible rubber surround 96 joins an edge of the sound radiator 90 to the enclosure 12. As shown, the surround 96 has an inner rib 98 that is secured by adhesive within a corresponding circular groove of the sound radiator 90.

A radially outer portion of the surround 96 comprises an annular flange 100 and a rib 102, that engages a corresponding circular groove 104 of the isolator 70. Note that this rib and groove arrangement is not absolutely essential, but it does facilitate assembly.

As shown, the annular mounting flange 46 of the basket 40 is secured to the enclosure 12, for example by screws (not shown), with the flanges 72 and 100 of the isolator 70 and surround 96 sandwiched between the mounting flange 46 and the enclosure 12. The mounting flange 46 includes, at the outer edge, a lip around the flanges 72 and 100. This configuration of the various flanges 46, 72 and 100 is dimensioned to ensure that requirements for creepage distances between the exterior and the interior of the subwoofer 10 meet appropriate specifications. For this purpose, it is assumed that the surround 96 will be treated as being capable of being torn or penetrated by a user.

The voice coil extender is connected by its connecting end portions 64 to the sound radiator 90. The rear side of the sound radiator 90 includes recesses 95 corresponding to the end portions 64, with the two components being glued together by a suitable adhesive. Further recesses in the central portion are adapted to engage an alignment tool. Preferably, both components are molded from a suitable plastic material. ABS plastic can be used, but any suitable plastic can be used that is sufficiently strong and rigid and that meets any other requirements, e.g. with respect to flammability.

With reference to FIG. 1, this shows a mounting and alignment tool 110. This tool 110 includes a planar base 112 and a circular portion 114 dimensioned to form a close fit within the yoke 34, so as to ensure accurate alignment. The circular portion 114 extends above the yoke 34, until it abuts the central alignment collar 56 of the voice coil extender 50, as shown on the left hand side of the collar 56 in FIG. 1. As shown on the right hand side of the collar 56 in FIG. 1, the mounting and alignment tool 110 includes three arcuate portions 116 that extend through the alignment collar 56 and through the apertures 84 of the central part 82 of the isolator 70. The arcuate portions 116 then engage the arcuate recesses 97 of the sound radiator 90. This arrangement ensures that the voice coil extender 50, secured to the sound radiator 90, and also the sound radiator 90 itself are both accurately aligned in the radial direction with the motor elements of the subwoofer 10, comprising the magnet 30, top plate 32 and yoke 34. More particularly, as the voice coil extender 50 is attached it the voice coil 36, this ensures that the voice coil 36 itself is accurately aligned and spaced in the gap between the top plate 32 and yoke 34, with desired radial spacing.

Further, the arcuate portions 116 slide through and engage corresponding arcuate slots 84 in the isolator 70, correspondingly to ensure alignment, in radial direction of the isolator 70.

With the mounting and alignment tool 110 in place, the flange 46 of the basket 40 can be secured to the flanges 72 and 100 of the isolator 70 and surround 96, ensuring proper alignment. Simultaneously, the spider can be attached to the voice coil former 38 and to the ring 48 of the basket, to ensure accurate location of the voice coil 36 in the flux gap with the various elements properly aligned, the alignment tool 110 can then be removed.

In known manner, the subwoofer 10, as noted above, also includes the two passive radiators 18. Each of these passive radiators 18 is provided with a respective isolator 70. Further, each of them include a respective sound radiator 90 and surround 96. Here, since there is no basket 40 or the like, the isolator 70 and the flanges of the surround 96 are secured, e.g. by screws and the like to the enclosure 12.

In known manner, to give desired characteristics to the passive drivers 16, each of the sound radiators 90 thereof is provided with a metal disc, dimensioned to give a desired mass to the passive driver.

To complete the subwoofer 10, each of the openings in the enclosure 12 for the active and passive drivers 14, 16 and 18 can be finished with an annular trim piece 122. Commonly, this trim piece 122 is an electrical insulator and serves to cover heads of screws or other conductive fasteners that would otherwise be visible on the exterior of the enclosure 12; this also serves to prevent unintended access to the screws, which can encourage a user to partially dismantle a subwoofer 10, and also provides electrical isolation. The screws may be countersunk, so that the annular trim piece 122 can be otherwise flush mounted to the exterior of the enclosure 12. The trim piece 122 can include cylindrical projections 124 for fitting into holes 126 of the housing 12. The screws engage the basket and as such must be insulated from the exterior. This construction ensures that the only access to the interior of the speaker is from the bottom, and hence it is then only necessary to put warning labels concerning a potential shock hazard on the bottom of the speaker. These are considered to be unsightly and one would not want them on any visible surface of the speaker. For some designs it may be possible to eliminate the screws and the hence the possible conductive path to the exterior, so that the trim piece 122 is not then necessary.

It will be understood that while a preferred embodiment of the invention has been described, numerous variations are possible within the scope and spirit of the present invention. While the sound radiator has been shown as a generally planar disc, it will be appreciated that a variety of different sound radiators can be employed. Indeed, a sound radiator could be in the nature of a conventional cone, although this would require an isolator of different configuration, and practically it would be difficult to find space for the isolator. While the voice coil extender has been shown with arcuate legs, connecting it to the sound radiator, it will be understood that the configuration of the voice coil extender can be varied in many respects. For example, it could be provided with generally cylindrical leg portions extending through the isolator. The number of leg portions can be varied, and conceivably it might be possible to have one, central leg if this is of sufficient strength.

1. A speaker comprising:
a magnet assembly defining a magnetic flux gap;
a voice coil mounted in the flux gap extending parallel to an axis of the speaker;
a sound radiator;
a connector, connecting the voice coil to the sound radiator, to drive the sound radiator; and
an isolator mounted between the sound radiator and the magnet assembly, to at least restrict access to electrically conductive parts the speaker that might become live while not restricting movement of the voice coil and the sound radiator.

2. A speaker as claimed in claim 1, including a basket, wherein the magnet assembly and the isolator are mounted to the basket, and wherein a spider is provided between the basket and voice coil to align the voice coil.

3. A speaker as claimed in claim 2, wherein the isolator includes a central portion including a plurality of openings permitting free movement of air through the isolator.

4. A speaker as claimed in claim 3, wherein the isolator includes a plurality of apertures and wherein the connector includes a plurality of leg portions extending through the apertures for free movement therein.

5. A speaker as claimed in claim 4, wherein the connector comprises a voice coil extender including a generally circular base portion and the plurality of leg portions extending from the base portion.

6. A speaker as claimed in claim 5, wherein the voice coil extender includes a central alignment collar secured to the base portion and including apertures for receiving an alignment tool.

7. A speaker as claimed in claim 5 or 6, wherein the leg portions are generally arcuate.

8. A speaker as claimed in claim 1, wherein the voice coil comprises a coil formed on a bobbin, and the connector comprises an extension of the bobbin.

9. A speaker as claimed in claim 4, wherein the sound radiator has a generally planar exterior surface for generating sound.

10. A speaker as claimed in claim 9, wherein the sound radiator includes a plurality of ribs on a rear face thereof, to reinforce the planar exterior surface.

11. A speaker as claimed in claim 10, including a flexible surround connected between an outer edge of the sound radiator and the basket.

12. A speaker as claimed in claim 11, wherein the isolator includes an annular flange, the surround is provided with an annular flange and the basket includes an annular flange, with the annular flange of the isolator being sandwiched between the flanges of the surround and the basket.

13. A speaker as claimed in claim 1, in combination with a housing, including an amplifier within the housing.

14. A combination as claimed in claim 13, including at least one passive driver mounted in the housing.

15. A combination as claimed in claim 14, wherein each passive driver includes an isolator, permitting free movement of air but preventing access to the interior of the housing from the exterior.

16. A speaker as claimed in claim 12, in combination with a housing, including an amplifier within the housing, wherein the speaker is mounted to the housing with fasteners engaging at least one of the flanges of the surround, the basket and the isolator.

17. A combination as claimed in claim 15, including a trim piece covering the fasteners on the exterior.

18. A combination as claimed in claim 17, including at least one passive driver, wherein each passive driver includes an isolator, permitting free movement of air but preventing access to the interior of the housing from the exterior.

19. An isolator for use in a speaker, the isolator comprising:
a central portion including a plurality of openings permitting free passage of air therethrough and a plurality of apertures for leg portions of a connector connecting, in use, a voice coil and a sound radiator, and permitting free movement of the leg portions therethrough; and
a peripheral portion including a mounting flange.

20. An isolator as claimed in claim 19, wherein the mounting flange is generally flat and annular and includes a groove for mounting a surround.

21. A voice coil extender comprising a base portion for connection to a voice coil and a plurality of legs extending generally parallel to one another away from the base portion.

22. A voice coil extender as claimed in claim 21, wherein the leg portions are generally arcuate.

23. A voice coil extender as claimed in claim 21, including a central alignment collar secured to the base portion and including apertures for engagement with an alignment tool.

24. A voice coil extender as claimed in claim 23, in combination with a sound radiator, wherein the sound radiator is attached to the leg portions of the voice coil extender.

25. A voice coil extender combined with the sound radiator as claimed in claim 24, wherein the sound radiator has a planar exterior surface and reinforcing ribs on the other side of the planar exterior surface.
